(19) United States
(12) Patent Application Publication
(10) Pub. No.: US 2011/0148351 A1
(43) Pub. Date: Jun. 23, 2011

(54) NONCONTACT ELECTRIC POWER RECEIVING DEVICE, NONCONTACT ELECTRIC POWER TRANSMITTING DEVICE, NONCONTACT ELECTRIC POWER FEEDING SYSTEM, AND ELECTRICALLY POWERED VEHICLE

(75) Inventor: Shinji Ichikawa, Toyota-shi (JP)

(73) Assignee: Toyota Jidosha Kabushiki Kaisha, Toyota-Shi (JP)

(21) Appl. No.: 13/037,425

(22) Filed: Mar. 1, 2011

Related U.S. Application Data
(62) Division of application No. 12/548,882, filed on Aug. 27, 2009.

(30) Foreign Application Priority Data
Sep. 18, 2008 (JP) JP2008-239622

(51) Int. Cl. H01F 38/14

(52) U.S. Cl. 320/108

(57) ABSTRACT

A first shielding box is disposed so that its first surface can be opposite to an electric power feeding unit. The first surface has an opening and remaining five surfaces thereof reflect, during reception of electric power from the electric power feeding unit, a resonant electromagnetic field (near field) generated in the surroundings of the electric power receiving unit. The electric power receiving unit is provided in the first shielding box to receive the electric power from the electric power feeding unit via the opening (first surface) of the first shielding box. A second shielding box has a similar configuration, i.e., has a second surface with an opening and remaining five surfaces thereof reflect the resonant electromagnetic field (near field) generated in the surroundings of the electric power feeding unit.

### CROSS-REFERENCE TO RELATED APPLICATIONS

This application is a divisional of U.S. patent application Ser. No. 12/548,882 filed Aug. 27, 2009, which claims priority of Japanese Patent Application No. 2008-239622 filed on Sep. 18, 2008 with the Japan Patent Office, the entire contents of which are hereby incorporated by reference.

### BACKGROUND OF THE INVENTION

1. Field of the Invention

The present invention relates to a noncontact electric power receiving device, a noncontact electric power transmitting device, a noncontact electric power feeding system, and an electrically powered vehicle, in particular, a shielding technique in an electric power feeding system that employs a resonance method to supply electric power from a power source external to a vehicle to the vehicle in a noncontact manner.

2. Description of the Background Art

As environmental friendly vehicles, electrically powered vehicles such as an electric vehicle and a hybrid vehicle are drawing attention greatly. These vehicles have a motor for generating driving force for traveling, and a rechargeable power storage device for storing electric power supplied to the motor. It should be noted that a hybrid vehicle is a vehicle having an internal combustion engine as a motive power source in addition to the motor, or a vehicle having a fuel cell as a direct-current power source for driving the vehicle in addition to the power storage device.

Among the hybrid vehicles, as with the electric vehicles, there is known a vehicle having a power storage device that is chargeable from a power source external to the vehicle. For example, a “plug-in hybrid vehicle” is known which has a power storage device that can be charged from a general household power source by connecting a receptacle of the power source in the house and a charging inlet in the vehicle via a charging cable.

Meanwhile, as an electric power transmission method, a wireless electric power transmission, which does not employ a power source cord or an electric power transmission cable, has been drawing attention in recent years. As predominant techniques of such wireless electric power transmission, there are three known techniques: electric power transmission employing electromagnetic induction, electric power transmission employing electromagnetic wave, and electric power transmission employing a resonance method.

Among them, the resonance method is a noncontact electric power transmission technique in which a pair of resonators (for example, a pair of self-resonant coils) are resonated in an electromagnetic field (near field) to transmit electric power through the electromagnetic field. The method allows transmission of a large electric power of several kW to a location in a relatively long distance (for example, several meters) away. The resonance method is disclosed in technical documents or the like, such as Andre Kurs et al, “Wireless Power Transfer via Strongly Coupled Magnetic Resonances”, [online], Jul. 6, 2007, SCIENCE, volume 317, p. 83-p. 86, [Searched on Sep. 12, 2007], the Internet <URL: http://www.sciencemag.org/cgi/reprint/317/5834/83.pdf>.

In the wireless electric power transmission employing the resonance method disclosed in “Wireless Power Transfer via Strongly Coupled Magnetic Resonances”, electric power is transmitted through the electromagnetic field by means of resonance. However, in the document, no specific discussion has been made as to a shielding method upon electric power transmission.

### SUMMARY OF THE INVENTION

In view of this, an object of the present invention is to provide a shielding method in a noncontact electric power receiving device, a noncontact electric power transmitting device, a noncontact electric power feeding system, and an electrically powered vehicle, each of which employs the resonance method.

According to the present invention, a noncontact electric power receiving device includes an electric power receiving resonator and an electromagnetism shielding material. The electric power receiving resonator receives electric power from an electric power transmitting resonator, which receives electric power from a power source to generate an electromagnetic field, by resonating with the electric power transmitting resonator through the electromagnetic field. The electromagnetism shielding material is provided to surround the electric power receiving resonator and has an opening at one side thereof to allow the electric power receiving resonator to receive the electric power from the electric power transmitting resonator.

It is preferable that the electromagnetism shielding material be formed in a shape of a box having the opening at its surface opposite to the electric power transmitting resonator when the electric power receiving resonator receives the electric power from the electric power transmitting resonator. The electric power receiving resonator is contained within the electromagnetism shielding material.

Further, it is preferable that the electromagnetism shielding material be formed in a shape of a box of rectangular solid. The surface provided with the opening in the electromagnetism shielding material is a surface with a maximal area in the rectangular solid.

It is preferable that the noncontact electric power receiving device further include an electromagnetism shielding plate. The electromagnetism shielding plate is configured to be capable of being interposed between the electric power transmitting resonator and the electric power receiving resonator so as to prohibit reception of the electric power from the electric power transmitting resonator.

It is preferable that the electric power transmitting resonator include a primary coil and a primary self-resonant coil. The primary coil receives the electric power from the power source. The primary self-resonant coil is fed with the electric power from the primary coil using electromagnetic induction to generate the electromagnetic field. The electric power receiving resonator includes a secondary self-resonant coil and a secondary coil. The secondary self-resonant coil receives the electric power from the primary self-resonant coil by resonating with the primary self-resonant coil through the electromagnetic field. The secondary coil extracts, using electromagnetic induction, the electric power received by the secondary self-resonant coil and outputs the electric power thus extracted.

According to the present invention, a noncontact electric power transmitting device includes an electric power transmitting resonator and an electromagnetism shielding material. The electric power transmitting resonator receives electric power from a power source to generate an electromagnetic field and transmitting the electric power to an electric power receiving resonator by resonating with the electric power receiving resonator through the electromagnetic field. The electromagnetism shielding material is provided to surround the electric power transmitting resonator and has an opening at one side thereof to allow the electric power to be transmitted from the electric power transmitting resonator to the electric power receiving resonator.

It is preferable that the electromagnetism shielding material be formed in a shape of a box having an opening at its surface opposite to the electric power receiving resonator when the electric power transmitting resonator transmits the electric power to the electric power receiving resonator. The electric power transmitting resonator is contained within the electromagnetism shielding material.

Further, it is preferable that the electromagnetism shielding material is formed in a shape of a box of rectangular solid. The surface provided with the opening in the electromagnetism shielding material is a surface with a maximal area in the rectangular solid.

It is preferable that the noncontact electric power transmitting device further include an electromagnetism shielding plate. The electromagnetism shielding plate is configured to be capable of being interposed between the electric power transmitting resonator and the electric power receiving resonator so as to prohibit transmission of the electric power to the electric power receiving resonator.

According to the present invention, a noncontact electric power feeding system includes any one of the above-described noncontact electric power receiving devices and any one of the above-described noncontact electric power transmitting devices.

According to the present invention, an electrically powered vehicle includes an electric power receiving resonator, a rectifier, an electric driving device, and an electromagnetism shielding material. The electric power receiving resonator receives electric power from an electric power transmitting resonator provided external to the vehicle, by resonating with the electric power transmitting resonator through an electromagnetic field. The rectifier rectifies the electric power received by the electric power receiving resonator. The electric driving device generates force to drive the vehicle, using the electric power rectified by the rectifier. The electromagnetism shielding material is provided to surround the electric power receiving resonator and has an opening at one side thereof to allow the electric power receiving resonator to receive the electric power from the electric power transmitting resonator.

In the present invention, an electric power transmitting resonator and an electric power receiving resonator, which resonate in an electromagnetic field, are utilized and electric power is transmitted in a noncontact manner from the electric power transmitting resonator to the electric power receiving resonator through the electromagnetic field. Here, an electromagnetism shielding material having an opening at one side thereof to allow the electric power receiving resonator to receive the electric power from the electric power transmitting resonator is provided to surround the electric power receiving resonator. Accordingly, a leakage electromagnetic field generated in the surroundings of the electric power receiving resonator is shielded by the electromagnetism shielding material without preventing the electric power receiving resonator from receiving the electric power from the electric power transmitting resonator. Thus, the present invention allows for appropriate restraint of the leakage electromagnetic field generated when electric power is transmitted in a noncontact manner using the resonance method from the electric power transmitting resonator to the electric power receiving resonator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an entire configuration of an electric power feeding system according to a first embodiment of the present invention.

FIG. 2 is an explanatory diagram of a principle of electric power transmission using a resonance method.

FIG. 3 shows a relation between a distance from an electric current source (magnetic current source) and strength of an electromagnetic field.

FIG. 4 shows structures of shielding boxes of FIG. 1 in detail.

FIG. 5 shows a relation between reflected electric power and a shielding distance.

FIG. 6 is an explanatory diagram of a structure for shielding a resonant electromagnetic field in a second embodiment.

### DESCRIPTION OF THE PREFERRED EMBODIMENTS

In the following, embodiments of the present invention will be described in detail with reference to figures. It should be noted that the same or equivalent portions in the figures are given the same reference characters and explanation therefor is not repeated.

### First Embodiment

FIG. 1 shows an entire configuration of an electric power feeding system according to a first embodiment of the present invention. Referring to FIG. 1, the electric power feeding system includes an electrically powered vehicle 100 and an electric power feeding device 200. Electrically powered vehicle 100 includes a secondary self-resonant coil 110, a secondary coil 120, a shielding box 190, a rectifier 130, a DC/DC converter 140, and a power storage device 150. Electrically powered vehicle 100 further includes a power control unit (hereinafter, also referred to as “PCU”) 160, a motor 170, and a vehicular ECU (Electronic Control Unit) 180.

Secondary self-resonant coil 110 is disposed in, for example, a lower portion of the vehicular body. Secondary self-resonant coil 110 is an LC resonant coil having opposite ends open (unconnected), and resonates with a primary self-resonant coil 240 (described below) of electric power feeding device 200 through an electromagnetic field to receive electric power from electric power feeding device 200. Note that it is assumed that the capacitance component of secondary self-resonant coil 110 is a stray capacitance of the coil, but capacitors connected to the opposite ends of the coil may be provided.

The number of wire turns of secondary self-resonant coil 110 is appropriately determined based on a distance to primary self-resonant coil 240 of electric power feeding device 200, a resonance frequency of primary self-resonant coil 240 and secondary self-resonant coil 110, and the like in order to obtain a large Q value (for example, Q>100), a large κ, and the like. A Q value indicates resonance strength of primary self-resonant coil 240 and secondary self-resonant coil 110 whereas κ indicates a degree of coupling thereof.

Secondary coil 120 is disposed coaxially with secondary self-resonant coil 110, and can be magnetically coupled to secondary self-resonant coil 110 by means of electromagnetic induction. Secondary coil 120 utilizes the electromagnetic induction to extract the electric power received by secondary self-resonant coil 110 and outputs it to rectifier 130.

Here, secondary self-resonant coil 110 and secondary coil 120 are contained in shielding box 190. Shielding box 190 is formed in the shape of, for example, a rectangular solid box, but may be formed in a cylindrical shape or polygonal column shape in conformity with the shapes of secondary self-resonant coil 110 and secondary coil 120. Shielding box 190 has an opening at its surface (lower surface in FIG. 1) opposite to primary self-resonant coil 240 when secondary self-resonant coil 110 receives electric power from primary self-resonant coil 240. The other portions thereof are disposed to cover secondary self-resonant coil 110 and secondary coil 120. Shielding box 190 may be formed from, for example, copper or an inexpensive member having an internal or external surface to which a fabric, a sponge, or the like each having an effect of shielding electromagnetic wave is attached.

Rectifier 130 rectifies the alternating-current power extracted by secondary coil 120. Based on a control signal from vehicular ECU 180, DC/DC converter 140 converts the electric power rectified by rectifier 130 into electric power of a voltage level for power storage device 150, and outputs it to power storage device 150. Where the electric power is received from electric power feeding device 200 during traveling of the vehicle, DC/DC converter 140 may convert the electric power rectified by rectifier 130 into electric power of system voltage, and supply it directly to PCU 160. Further, DC/DC converter 140 is not necessarily essential, and the alternating-current power extracted by secondary coil 120 may be directly supplied to power storage device 150 after being rectified by rectifier 130.

Power storage device 150 is a rechargeable direct-current power source and is constituted by, for example, a secondary battery such as a lithium ion or nickel hydrogen battery. Power storage device 150 stores the electric power supplied from DC/DC converter 140 as well as regenerative electric power generated by motor 170. Power storage device 150 supplies the stored electric power to PCU 160. It should be noted that a capacitor having a large capacitance may be employed as power storage device 150 and may be any electric power buffer as long as it is capable of temporarily storing the electric power supplied from electric power feeding device 200 as well as the regenerative electric power supplied from motor 170 and is capable of supplying the stored electric power to PCU 160.

PCU 160 drives motor 170 using the electric power sent from power storage device 150 or the electric power directly supplied from DC/DC converter 140. In addition, PCU 160 rectifies the regenerative electric power generated by motor 170 and outputs it to power storage device 150 to charge power storage device 150. Motor 170 is driven by PCU 160 to generate force to drive the vehicle and outputs it to a driving wheel. Furthermore, motor 170 generates electric power by means of kinetic energy received from the driving wheel or an engine (not shown) and outputs the generated regenerative electric power to PCU 160.

Vehicular ECU 180 controls DC/DC converter 140 during feeding of electric power from electric power feeding device 200 to electrically powered vehicle 100. For example, by controlling DC/DC converter 140, vehicular ECU 180 controls voltage between rectifier 130 and DC/DC converter 140 to be at a predetermined target voltage. In addition, during traveling of the vehicle, vehicular ECU 180 controls PCU 160 based on a traveling state of the vehicle or State Of Charge (hereinafter, also referred to as “SOC”) of power storage device 150.

Meanwhile, electric power feeding device 200 includes an alternating-current power source 210, a high-frequency electric power driver 220, a primary coil 230, primary self-resonant coil 240, and a shielding box 250.

Alternating-current power source 210 is a power source external to the vehicle, and is, for example, a system power source. High-frequency electric power driver 220 converts electric power received from alternating-current power source 210 into high-frequency electric power, and supplies the converted high-frequency electric power to primary coil 230. Note that the high-frequency electric power generated by high-frequency electric power driver 220 has a frequency of, for example, 1 MHz to 10 and several MHz.

Primary coil 230 is disposed coaxially with primary self-resonant coil 240, and can be magnetically coupled to primary self-resonant coil 240 by means of electromagnetic induction. Using the electromagnetic induction, primary coil 230 feeds primary self-resonant coil 240 with the high-frequency electric power supplied from high-frequency electric power driver 220.

Primary self-resonant coil 240 is disposed in the vicinity of, for example, the land surface. Primary self-resonant coil 240 is also an LC resonant coil having opposite ends open (unconnected), and resonates with secondary self-resonant coil 110 of electrically powered vehicle 100 through the electromagnetic field to transmit the electric power to electrically powered vehicle 100. Noted that it is also assumed that the capacitance component of primary self-resonant coil 240 is stray capacitance of the coil but capacitors connected to the opposite ends of the coil may be provided.

The number of wire turns of primary self-resonant coil 240 is also appropriately determined based on a distance to secondary self-resonant coil 110 of electrically powered vehicle 100, the resonance frequency of primary self-resonant coil 240 and secondary self-resonant coil 110, and the like, in order to obtain a large Q value (for example, Q>100), a large degree of coupling κ, and the like.

Here, as with secondary self-resonant coil 110 and secondary coil 120 of the vehicle, primary self-resonant coil 240 and primary coil 230 are contained in shielding box 250. Shielding box 250 is also formed in the shape of, for example, a rectangular solid box, but may be formed in a cylindrical shape or polygonal column shape in conformity with the shapes of primary self-resonant coil 240 and primary coil 230. Shielding box 250 has an opening at its surface (upper surface in FIG. 1) opposite to secondary self-resonant coil 110 when the electric power is transmitted from primary self-resonant coil 240 to secondary self-resonant coil 110. The other portions thereof are disposed to cover primary self-resonant coil 240 and primary coil 230. Shielding box 250 may be also formed from, for example, copper or an inexpensive member having an internal or external surface to which a fabric, a sponge, or the like each having an effect of shielding electromagnetic wave is attached.

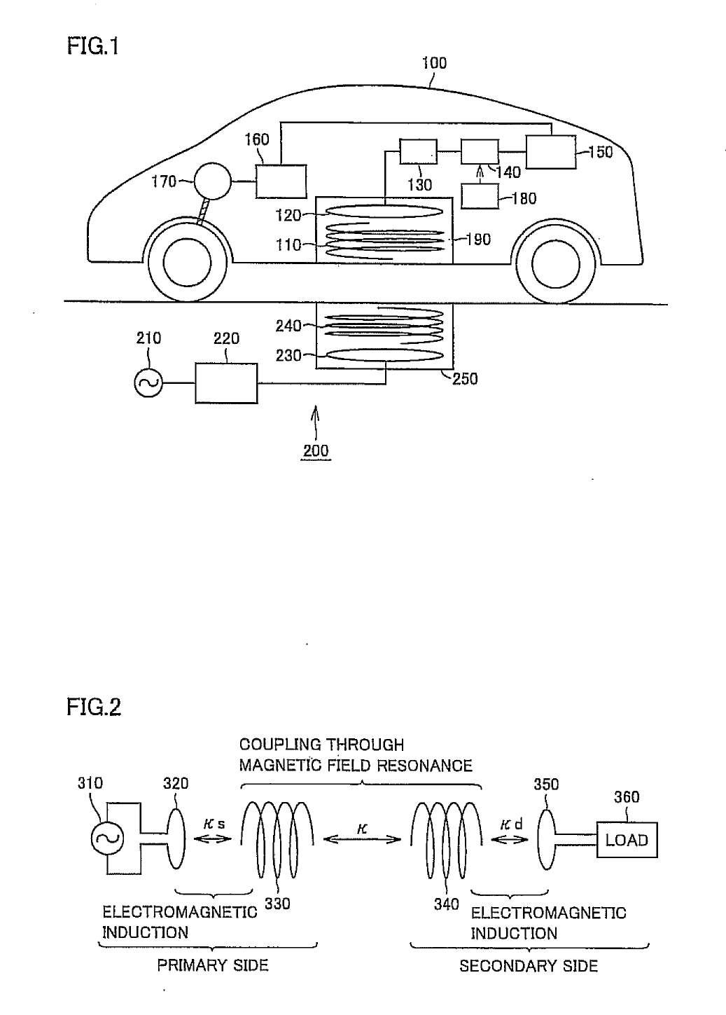

FIG. 2 is an explanatory diagram of a principle of the electric power transmission using the resonance method. Referring to FIG. 2, in the resonance method, as with resonance of two tuning forks, two LC resonant coils having the same natural frequency resonate in an electromagnetic field (near field) to transmit electric power from one coil to the other coil via the electromagnetic field.

Specifically, a primary coil 320 is connected to a high-frequency power source 310 to feed electric power having a high frequency of 1 MHz to 10 and several MHz, to a primary self-resonant coil 330 magnetically coupled to a primary coil 320 by means of electromagnetic induction. Primary self-resonant coil 330 is an LC resonator having an inductance intrinsic to the coil and a stray capacitance, and resonates through the electromagnetic field (near field) with a secondary self-resonant coil 340 having the same resonance frequency as that of primary self-resonant coil 330. This transfers energy (electric power) from primary self-resonant coil 330 to secondary self-resonant coil 340 via the electromagnetic field. The energy (electric power) thus transferred to secondary self-resonant coil 340 is extracted, using electromagnetic induction, by a secondary coil 350 magnetically coupled to secondary self-resonant coil 340, and is supplied to a load 360. It should be noted that the electric power transmission according to the resonance method is realized when the Q value, which represents resonance strength of primary self-resonant coil 330 and secondary self-resonant coil 340, is for example greater than 100.

Now, correspondences with those in FIG. 1 will be described. Alternating-current power source 210 and high-frequency electric power driver 220 of FIG. 1 correspond to high-frequency power source 310 of FIG. 2. Primary coil 230 and primary self-resonant coil 240 of FIG. 1 respectively correspond to primary coil 320 and primary self-resonant coil 330 of FIG. 2. Secondary self-resonant coil 110 and secondary coil 120 of FIG. 1 respectively correspond to secondary self-resonant coil 340 and secondary coil 350 of FIG. 2. Rectifier 130 and the components disposed thereafter in FIG. 1 are generally illustrated as load 360.

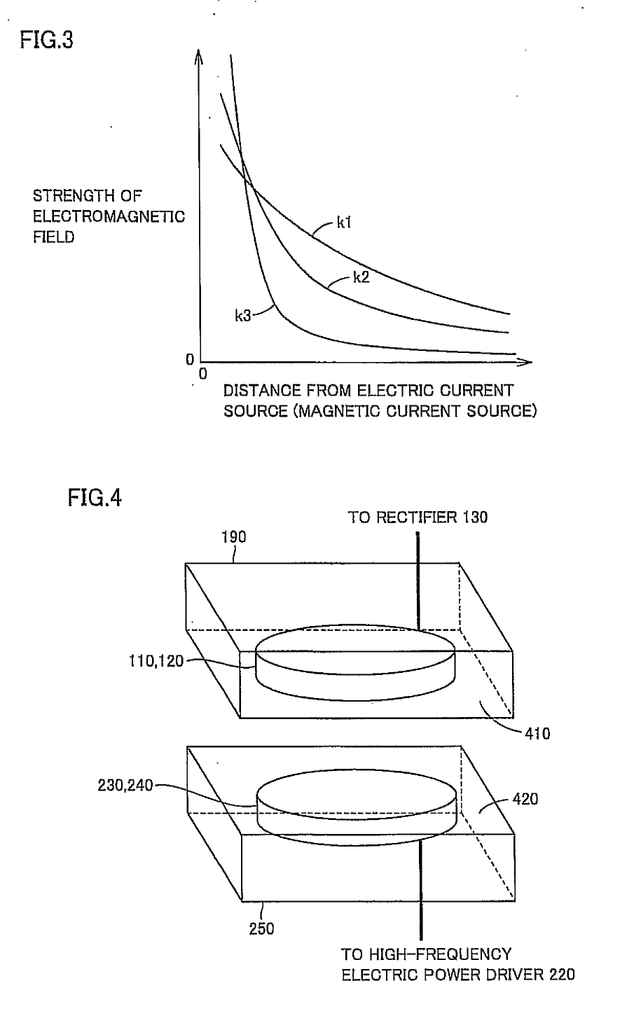

FIG. 3 shows a relation between a distance from an electric current source (magnetic current source) and the strength of the electromagnetic field. Referring to FIG. 3, the electromagnetic field is constituted by three components. A component represented by a curved line k1 is inversely proportional to a distance from a wave source and is referred to as “radiation electric field”. A component represented by a curved line k2 is inversely proportional to the square of the distance from the wave source, and is referred to as “induction electric field”. A component represented by a curved line k3 is inversely proportional to the cube of the distance from the wave source and is referred to as “electrostatic field”.

The “electrostatic field” is an area in which the strength of the electromagnetic wave decreases drastically with the distance from the wave source. In the resonance method, energy (electric power) is transferred using a near field (evanescent field) in which this “electrostatic field” is dominant. In other words, in the near field in which the “electrostatic field” is dominant, a pair of resonators (for example, a pair of LC resonant coils) having the same natural frequency are resonated to transmit energy (electric power) from one resonator (primary self-resonant coil) to the other resonator (secondary self-resonant coil). Since the “electrostatic field” does not propagate the energy to a location far away, the resonance method achieves less energy loss in electric power transmission as compared with the case of an electromagnetic wave that transmits energy (electric power) using the “radiation electric field”, which propagates energy to a location far away.

FIG. 4 shows the structures of shielding boxes 190, 250 of FIG. 1 more in detail. It should be noted that in FIG. 4, a unit constituted by secondary self-resonant coil 110 and secondary coil 120 (hereinafter, also referred to as “electric power receiving unit”) is illustrated in a cylindrical shape for brevity. The same holds true for a unit constituted by primary self-resonant coil 240 and primary coil 230 (hereinafter, also referred to as “electric power feeding unit”).

Referring to FIG. 4, shielding box 190 is disposed so that its maximal area surface 410 can be opposite to the electric power feeding unit. Surface 410 has the opening and its remaining five surfaces reflect a resonant electromagnetic field (near field) generated in the surroundings of the electric power receiving unit when receiving electric power from the electric power feeding unit. The electric power receiving unit constituted by secondary self-resonant coil 110 and secondary coil 120 is provided in shielding box 190 to receive electric power from the electric power feeding unit via the opening (surface 410) of shielding box 190. A reason why surface 410 having the maximal area is disposed so that it can be opposite to the electric power feeding unit is to secure efficiency of transmission from the electric power feeding unit to the electric power receiving unit as much as possible.

Likewise, shielding box 250 is disposed so that its maximal area surface 420 can be opposite to the electric power receiving unit. Surface 420 has the opening and its remaining five surfaces reflect the resonant electromagnetic field (near field) generated in the surroundings of the electric power feeding unit when transmitting electric power to the electric power receiving unit. The electric power feeding unit constituted by primary self-resonant coil 240 and primary coil 230 is provided in shielding box 250 to transmit electric power to the electric power receiving unit via the opening (surface 420) of shielding box 250. A reason why surface 420 having the maximal area is disposed so that it can be opposite to the electric power receiving unit is to secure efficiency of transmission from the electric power feeding unit to the electric power receiving unit as much as possible.

The sizes of shielding boxes 190, 250, in particular, the size of shielding box 190, which is mounted on the vehicle, is determined in consideration of a mounting space and the electric power transmission efficiency. Namely, a smaller shielding box 190 is better in view of the mounting space in the vehicle while a larger shielding box 190 is more preferable in view of the electric power transmission efficiency.

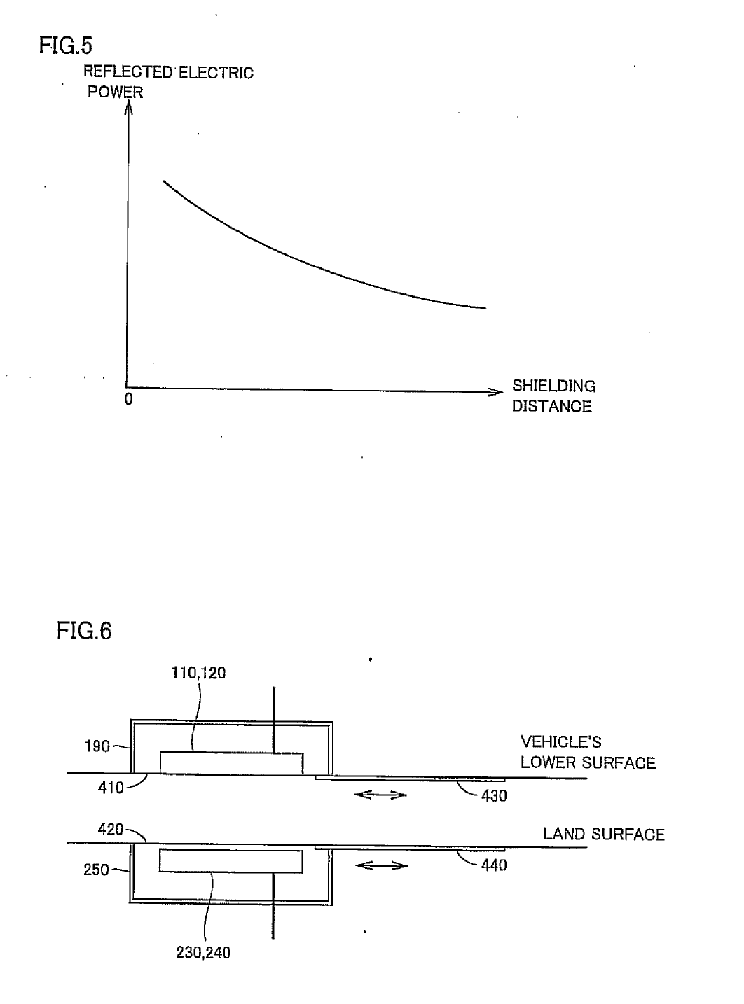

FIG. 5 shows a relation between reflected electric power and a shielding distance. Referring to FIG. 5, the longitudinal axis represents reflected electric power whereas the lateral axis represents a distance (shielding distance) between the electromagnetic current source (secondary self-resonant coil 110) and shielding box 190. As shown in FIG. 5, as the shielding distance is shorter, the reflected electric power is greater. In other words, as the shielding distance is longer, the reflected electric power is smaller. Hence, from the viewpoint of the efficiency, a larger shielding box 190 is preferable.

Accordingly, shielding box 190 is designed as large as allowed by a space, rather than minimizing shielding box 190 only in consideration of the mounting space in the vehicle. Similarly, it is preferable that shielding box 250 of electric power feeding device 200 be also designed as large as allowed by a space.

As described above, in the first embodiment, in electrically powered vehicle 100, the electric power receiving unit is contained within the shielding box 190 having the opening at its one side to enable reception of electric power from the electric power feeding unit. Accordingly, shielding box 190 shields the leakage electromagnetic field generated in the surroundings of the electric power receiving unit without preventing the electric power receiving unit from receiving the electric power from the electric power feeding unit. Likewise, in electric power feeding device 200, the electric power feeding unit is contained within shielding box 250 having the opening at its one side to enable transmission of electric power from the electric power feeding unit to the electric power receiving unit. Accordingly, shielding box 250 shields the leakage electromagnetic field generated in the surroundings of the electric power feeding unit without preventing the electric power feeding unit from transmitting the electric power to the electric power receiving unit. As such, according to the first embodiment, the leakage electromagnetic field, which is generated when electric power is transmitted in a noncontact manner using the resonance method from the electric power feeding unit to the electric power receiving unit, can be appropriately restrained.

### Second Embodiment

In a second embodiment, a configuration for prohibiting reception of electric power in an electrically powered vehicle and a configuration for prohibiting transmission of electric power in an electric power feeding device will be described.

FIG. 6 is an explanatory diagram of a structure for shielding a resonant electromagnetic field in the second embodiment. Referring to FIG. 6, in the second embodiment, shielding plates 430, 440 are further provided in addition to the configuration of the first embodiment shown in FIG. 4.

Shielding plate 430 is configured to be slidable and can cover surface 410 of shielding box 190. When the electrically powered vehicle receives electric power from the electric power feeding device, shielding plate 430 is moved to expose surface 410. Meanwhile, when no electric power is received or reception of electric power needs to be stopped urgently due to some abnormality, shielding plate 430 is moved to be interposed between the electric power receiving unit and the electric power feeding unit. Shielding plate 430 is moved using an appropriate actuator, under control of, for example, the vehicular ECU (not shown).

Shielding plate 440 is also configured to be slidable and can cover surface 420 of shielding box 250. When transmitting electric power from the electric power feeding device to the electrically powered vehicle, shielding plate 440 is moved to expose surface 420. Meanwhile, when no electric power is transmitted or transmission of electric power needs to be stopped urgently due to some abnormality, shielding plate 440 is moved to be interposed between the electric power feeding unit and the electric power receiving unit.

As described above, according to the second embodiment, since shielding plate 430 is provided, the electrically powered vehicle can be securely prohibited from receiving electric power transmitted from the electric power feeding device. Likewise, since the electric power feeding device is provided with shielding plate 440, electric power transmission from the electric power feeding device can be securely prohibited at the moment of an emergency or the like.

In each of the embodiments described above, it is assumed that the capacitance component of each of secondary self-resonant coil 110 and primary self-resonant coil 240 is the stray capacitance of each of the resonant coils. However, a capacitor may be connected between the ends of each of secondary self-resonant coil 110 and primary self-resonant coil 240 to form a capacitance component.

Also in the description above, it is assumed that secondary coil 120 is used to extract electric power from secondary self-resonant coil 110 by means of electromagnetic induction and primary coil 230 is used to feed electric power to primary self-resonant coil 240 by means of electromagnetic induction. However, secondary coil 120 may not be provided, the electric power may be directly extracted from secondary self-resonant coil 110 and supplied to rectifier 130, and the electric power may be directly fed from high-frequency electric power driver 220 to primary self-resonant coil 240.

Further, in the description above, it is assumed that the coils are resonated to transmit electric power. Instead of each resonant coil, a highly dielectric disk may be used as a resonator.

Note that the electrically powered vehicle may be a hybrid vehicle having an engine for a motive power source in addition to motor 170. Note also that the electrically powered vehicle may be a fuel cell vehicle having a fuel cell mounted thereon as a direct-current power source.

Further, in the description above, it is assumed that the electric power supplied from electric power feeding device 200 is charged to power storage device 150, but the present invention is applicable to a vehicle having no power storage device. Namely, the present invention is applicable to an electrically powered vehicle that travels using a motor while receiving electric power from an electric power feeding device.

It should be noted that, in the description above, secondary self-resonant coil 110 and secondary coil 120 constitute one example of an “electric power receiving resonator” in the present invention, and primary self-resonant coil 240 and primary coil 230 constitute one example of an “electric power transmitting resonator” in the present invention. Further, shielding box 190 corresponds to one example of an “electromagnetism shielding material provided to surround the electric power receiving resonator” in the present invention, and shielding plate 430 corresponds to one example of an “electromagnetism shielding plate” in the present invention. Furthermore, shielding box 250 corresponds to one example of an “electromagnetism shielding material provided to surround the electric power transmitting resonator” in the present invention, and PCU 160 and motor 170 constitute one example of an “electric driving device” in the present invention.

Although the present invention has been described and illustrated in detail, it is clearly understood that the same is by way of illustration and example only and is not to be taken by way of limitation, the scope of the present invention being interpreted by the terms of the appended claims.

1. A noncontact electric power transmitting device for an electrically powered vehicle comprising:
an electric power transmitting resonator for receiving electric power from a power source to generate an electromagnetic field, and transmitting the electric power to an electric power receiving resonator by resonating with said electric power receiving resonator through said electromagnetic field; and
an electromagnetism shielding material provided to surround said electric power transmitting resonator and having an opening at one side thereof to allow said electric power transmitting resonator to transmit the electric power to said electric power receiving resonator.

2. The noncontact electric power transmitting device for an electrically powered vehicle according to claim 1, wherein:
said electromagnetism shielding material is formed in a shape of a box having the opening at its surface opposite to said electric power receiving resonator when said electric power transmitting resonator transmits the electric power to said electric power receiving resonator, and
said electric power transmitting resonator is contained within said electromagnetism shielding material.

3. The noncontact electric power transmitting device for an electrically powered vehicle according to claim 2, wherein:
said electromagnetism shielding material is formed in a shape of a box of rectangular solid, and
the surface provided with the opening in said electromagnetism shielding material is a surface with a maximal area in said rectangular solid.

4. The noncontact electric power transmitting device for an electrically powered vehicle according to claim 1, further comprising an electromagnetism shielding plate configured to be capable of being interposed between said electric power transmitting resonator and said electric power receiving resonator so as to prohibit transmission of the electric power from said electric power transmitting resonator.

5. The noncontact electric power transmitting device for an electrically powered vehicle according to claim 1, wherein:
said electric power transmitting resonator includes a primary self-resonant coil for receiving the electric power from the power source to generate said electromagnetic field; and
said electric power receiving resonator includes a secondary self-resonant coil for receiving the electric power from said primary self-resonant coil by resonating with said primary self-resonant coil through said electromagnetic field, and outputting the electric power.

6. The noncontact electric power transmitting device for an electrically powered vehicle according to claim 5, wherein:
said electric power transmitting resonator further includes a primary coil for receiving the electric power from the power source, and feeding the electric power to said primary self-resonant coil using electromagnetic induction; and
said electric power receiving resonator further includes a secondary coil extracting, using electromagnetic induction, the electric power received by said secondary self-resonant coil and outputting the electric power thus extracted.
